(19) United States
(12) Patent Application Publication
(10) Pub. No.: US 2026/0145818 A1
(43) Pub. Date: May 28, 2026

(54) SMALL SATELLITE DOCKING ADAPTER FOR POWER TRANSFER AND STRUCTURAL APPLICATIONS

(71) Applicant: Arizona Board of Regents, Tucson, AZ (US)

(72) Inventors: Jekan Thangavelautham, Tucson, AZ (US); Athip Thirupathi Raj, Tucson, AZ (US); Nicolas Cooper Gross, Tucson, AZ (US); Adrien Bouskela, Tucson, AZ (US); Sergey Shkarayev, Tucson, AZ (US); Roshan Adhikari, Tucson, AZ (US)

(21) Appl. No.: 19/178,520

(22) Filed: Apr. 14, 2025

Related U.S. Application Data
(60) Provisional application No. 63/633,295, filed on Apr. 12, 2024.
(60) Provisional application No. 63/635,174, filed on Apr. 17, 2024.

(51) Int. Cl. B64G 1/64; B64G 1/10; B64G 1/22; G02B 23/16

(52) U.S. Cl. CPC B64G 1/6464; B64G 1/1057; B64G 1/223; B64G 1/6457; G02B 23/16

(57) ABSTRACT

A small satellite docking adapter includes a probe adapter, the probe adapter including: one or more latches; one or more springs; and a cone adapter, the cone adapter including: one or more grooves, wherein: the one or more latches are configured to couple to the one or more grooves; and the one or more springs are configured to cause the one or more latches to engage with the one or more grooves to lock the probe adapter to the cone adapter, and to disengage with the one or more grooves to unlock the probe adapter and the cone adapter.

### CROSS REFERENCE TO RELATED APPLICATIONS

This application claims the benefit of U.S. Provisional Application Ser. No. 63/635,174, filed Apr. 17, 2024, and U.S. Provisional Application Ser. No. 63/633,295, filed Apr. 12, 2024; both of which are hereby incorporated by reference in their entirety.

### STATEMENT REGARDING FEDERALLY SPONSORED RESEARCH OR DEVELOPMENT

This invention was made with government support under Grant number 80NSSC19M0197 awarded by the National Aeronautics and Space Administration. The government has certain rights in the invention.

### TECHNICAL FIELD

The present disclosure generally relates to small satellite docking adapter for power transfer and structural applications, and to a reconfigurable space telescope using the docking adapter for telescope payloads.

### BACKGROUND

With the recent surge in the development of space technologies and the growing space economy, the need for large space structures is more present than ever. Large space structures facilitate many space activities requiring larger payloads, power, and propulsion systems. These activities can include long-duration space exploration and the construction of facilities on the lunar surface. To enable such large structures, modular truss structures must be created, which can be assembled autonomously. Truss structures have been used in space for many applications, most notably the Integrated Truss Structure (ITS) on the International Space Station (ISS). The ITS creates attachment points for solar arrays and external payload and contains electrical and cooling utility lines. The ITS has allowed the ISS to receive numerous repairs and upgrades, increasing its lifetime. Creating modular truss structures to be autonomously assembled reduces the risk and cost of deployment and enables repairs, upgrades, and future expansion.

In the ever-evolving landscape of technological advancements and the intensifying competition in space exploration, the significance of Space Domain Awareness (SDA) has reached unprecedented levels. There is a growing importance of SDA, particularly in the cislunar domain, where human activities extend beyond Earth's orbit. The focus is on tracking satellites, detecting and tracking near-earth asteroids, managing space debris, and mitigating collision risks to maintain the sustainability of space operations. As humanity continues to push the boundaries of space exploration, the space environment has become increasingly congested, contested, and competitive. The growing number of satellites, space debris, near-earth asteroids, and other objects in orbit has raised concerns about potential collisions and the creation of more debris, a scenario known as the Kessler Syndrome. To address these challenges, the role of SDA has become pivotal in providing essential information for monitoring and regulating space traffic and mitigating the risks associated with the congestion of space. Continuously tracking the location of satellites and other objects in orbit enables operators to make informed decisions to avoid potential collisions. This not only ensures the safety of space assets but also enhances the overall efficiency of space operations. The information provided by SDA allows for precise orbital maneuvers, optimizing the positioning of satellite constellations and minimizing the probability of accidents. One of the primary concerns in the realm of space activities is the creation of the Kessler Syndrome. This domino effect of collisions, resulting in an ever-growing cloud of debris, poses a severe threat to both operational satellites and future space missions. SDA acts as a crucial tool in preventing the onset of the Kessler Syndrome by providing real-time data on the location of objects in space. This information enables operators to adjust trajectories and avoid potential collisions, thereby breaking the chain reaction that could lead to irreversible consequences.

### BRIEF DESCRIPTION OF THE DRAWINGS

Reference should be made to the following detailed description which should be read in conjunction with the following figures, wherein like numerals represent like parts.

FIG. 1 is an illustrative example of a robotically assembled autonomous space station operating in cislunar space, consistent with the present disclosure.

FIG. 2A is a perspective view of a docking adapter, consistent with the present disclosure.

FIG. 2B is a cross-sectional view of the docking adapter of FIG. 2A, consistent with the present disclosure.

FIG. 2C is a close-up cross-sectional view of an internal latch for the docking adapter of FIG. 2A, consistent with the present disclosure.

FIG. 3A is a perspective view of a unit control truss, consistent with the present disclosure.

FIG. 3B is a perspective view of a unit docked truss, consistent with the present disclosure.

FIG. 4 is Table 1, a list of important material properties, consistent with the present disclosure.

FIG. 5A depicts the total deformation for a load of 10 N in an analysis of a unit control truss, consistent with the present disclosure.

FIG. 5B is an example of a force-deformation graph for the analysis of FIG. 5A, consistent with the present disclosure.

FIG. 5C is an example of a stress-strain graph for the analysis of FIG. 5A, consistent with the present disclosure.

FIG. 6A depicts the total deformation for a load of 10 N in an analysis of a unit docked truss, consistent with the present disclosure.

FIG. 6B is an example of a force-deformation graph for the analysis of FIG. 6A, consistent with the present disclosure.

FIG. 6C is an example of a stress-strain graph for the analysis of FIG. 6A, consistent with the present disclosure.

FIG. 7 is an illustrative block diagram of one possible software architecture for design and positioning software for small satellites.

FIG. 8 is Table 2, an example of user input for the design and positioning software of FIG. 7, consistent with the present disclosure.

FIG. 9 is an functional block diagram of one example of a living truss, consistent with the present disclosure.

FIG. 10 is a perspective view and two detail views of a living truss, consistent with the present disclosure.

FIG. 11 is a perspective view of an illustrative example of a reconfigurable space telescope for long duration observations, consistent with the present disclosure.

FIG. 12 is an example 16U CubeSat with a stowed 150 mm telescope, consistent with the present disclosure.

FIG. 13 is an example of the 16U CubeSat of FIG. 12 with a telescope in the deployed configuration, consistent with the present disclosure.

FIG. 14A depicts an optical path for the telescope of FIG. 12 at f/10, consistent with the present disclosure.

FIG. 14B depicts an optical path for the telescope of FIG. 12 at f/2, consistent with the present disclosure.

FIG. 15 is an example of station reconfiguration to task a subset of telescopes to a specific target, consistent with the present disclosure.

Although the following Detailed Description will proceed with reference being made to illustrative embodiments, many alternatives, modifications and variations thereof will be apparent to those skilled in the art.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present disclosure, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

In light of the recent advancements in space technology and the burgeoning space economy, the demand for large space structures has reached unprecedented levels. These structures are essential for various space activities that require substantial payloads, power, and propulsion systems, including prolonged space exploration and lunar surface facility construction. To achieve this, the development of modular truss structures capable of autonomous assembly is imperative. Truss structures, exemplified by the ITS on the ISS, provide attachment points for solar arrays and external payloads, accommodating electrical and cooling utility lines. The ITS has significantly extended the operational lifespan of the ISS through repairs and upgrades. Disclosed herein are truss modules designed for autonomous assembly, for example, in deep space and lunar environments. Utilizing robotic arms akin to the Mobile Base System (MBS) on the ISS, these modules incorporate probe and cone docking adapters for secure attachment.

Disclosed herein is a probe and cone satellite docking adapter capable of in-space servicing applications, which may include, but are not limited to, on-orbit maintenance and repair, assembly, and construction. The disclosed system enables mission flexibility, and increases the lifespan of small and large satellites. Capabilities of the disclosed system may include fitting within a 1U form factor, and the capability for 10-100 W power transfer and 1 Gbps data transfer. Shape Memory Alloy (SMA) springs enable the docking adapters to lock and unlock, allowing expansion in all directions. Analyses of control groups and docked groups of trusses have been performed for various load conditions.

Truss structures have been used extensively in space applications, acting as supporting structures for instruments like solar arrays and other external payloads. Notable examples of truss structures in space include the metering truss in the Hubble Space Telescope, the Integrated Science Instrument Module (ISIM) truss in the James Webb Space Telescope (JWST), and the Integrated Truss Structure (ITS) in the International Space Station (ISS).

The system disclosed herein consists of truss modules that can be autonomously assembled, and a docking designer software tool that may be used to design and optimize the locations of docking adapters on spacecraft. Autonomous assembly of the modules can be done using robotic arms that move across the modules on rails. The truss modules include the disclosed probe and cone docking adapters that utilize geometry for soft capture and mechanical latches for hard capture. The adapters can lock and unlock using SMA springs, which actuate the latches. A combination of the probe and cone adapters may be attached to each truss module, allowing for expansion in all directions.

In an embodiment, docking may consist of four main steps. First, alignment and soft capture using geometry to correct for orientational mismatches. Second, hard capture (second stage) using spring-loaded latch mechanisms to lock and prevent separation. Third, power/data transfer through pogo-pin interfaces between the satellites. And fourth, undocking using the SMA springs to release the latches.

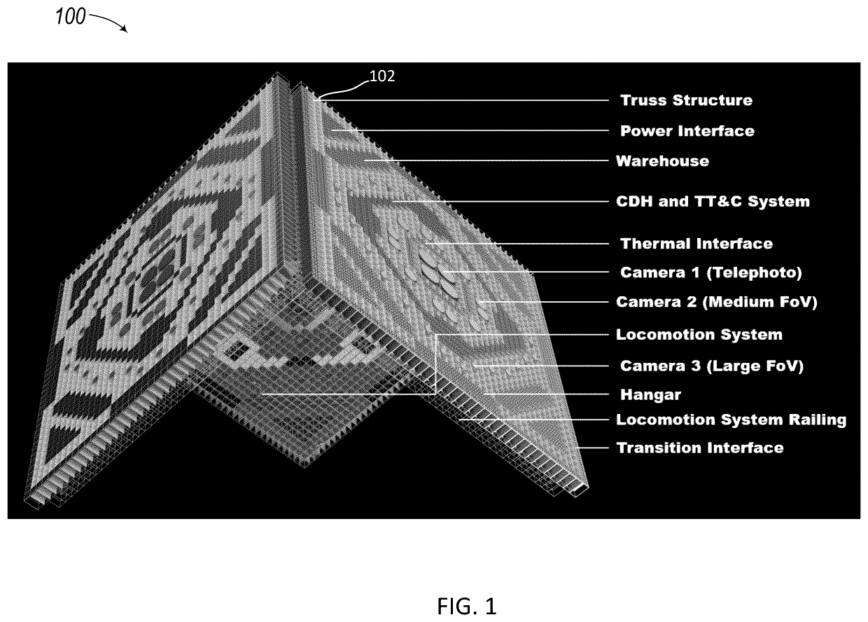

In-space assembly may be used to construct large structures in space autonomously using robots. Several robotic construction concepts have been proposed over the past years, involving the docking of satellite building blocks to make a superstructure. FIG. 1 is an illustrative example of a robotically assembled autonomous space station 100 operating in cislunar space. The example autonomous space station of FIG. 1 functions as an observation platform, which may include cameras, telescopes, and other imaging equipment and their supporting systems are to be mounted on an expendable truss structure. As shown in FIG. 1, the autonomous space station 100 is constructed using a truss structure 102, which may use the small satellite docking adapter disclosed herein for robotic assembly of the autonomous space station 100.

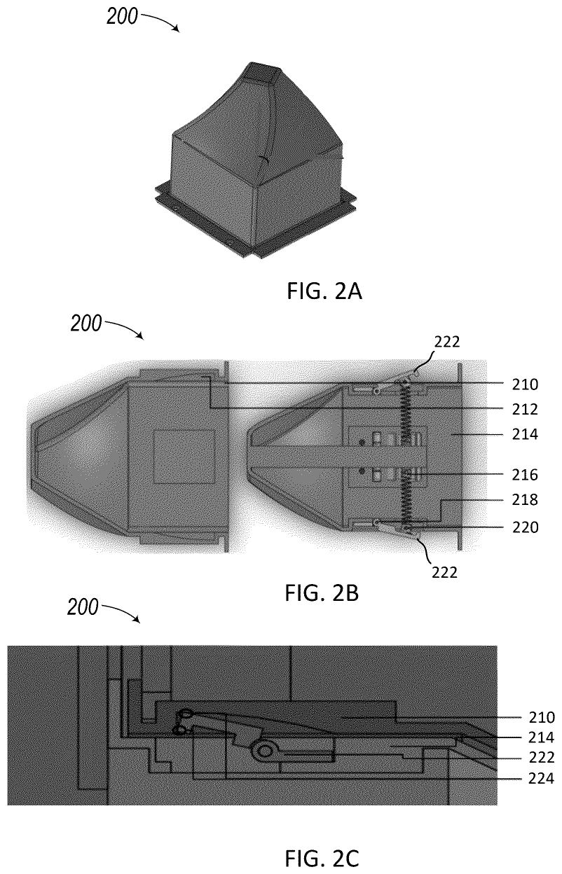

FIG. 2A is a perspective view of a docking adapter 200, FIG. 2B is a cross-sectional view of the docking adapter 200, and FIG. 2C is a close-up cross-sectional view of an internal latch for the docking adapter 200, consistent with the present disclosure. In docked trusses, for example, the truss structure 102 of the autonomous space station 100, the docking adapters 200 act as the connections that bind the trusses together rather than the trusses being welded or fastened together.

FIG. 2B is a cross-sectional view of the docking adapter 200 of FIG. 2A, and FIG. 2C is a close-up cross-sectional view of an internal latch 222 for the docking adapter of FIG. 2A. The docking adapter 200 consist of a two-stage geometric cone adapter 210 and a probe adapter 214. The first stage, soft capture, is done using the geometry of the adapters, which allows the adapters to mate despite any x-y translational or z rotational misalignment. The geometry of the cone adapter 210 has generally a “twisted” cone shape, with the tip of the cone shape truncated (i.e., “squared off”), as shown. The cone adapter is configured to receive, in the “twisted” cone shape portion, the probe adapter 214 (i.e., the cone adapter 2110 is a female part and the probe adapter 214 is a male part). Accordingly, the probe adapter 214 has an end portion 230 that has a “twisted” and truncated cone shape that fits within the cone adapter 210. The twisted shape, as shown herein, allows for alignment between the cone adapter 210 and the probe adapter 214, and also stops rotational movement of the probe adapter 214 once the twisted portions mate to one another. Adapters can be formed of, for example, so-called “space-ready” materials, for example treated al, treated steel, treated titanium, and/or other inorganic materials and/or inorganic treated materials, inorganic polymers, inorganic elastomeric materials, organic materials such as wood that have been treated with inorganic compounds, etc., and/or any other custom/proprietary/future-developed material that can withstand an orbital and/or planetary environment.

The second stage, hard capture, is done using one or more spring-loaded latches 222 located on the surface of the probe adapter 214. After soft capture, the latches 222 are extended into curved grooves 212 located inside the cone adapter 210, and engage latch contacts 224. This locks the cone adapter 210 and the probe adapter 214 together, preventing separation. The probe adapter 214 includes one or more springs 216. In an embodiment, the springs 216 may be an SMA material. To unlock, the SMA springs 216 are Joule heated, compressing the SMA springs 216 and allowing for the cone adapter 210 and the probe adapter 214 to separate. When the docking adapter 200 completes hard capture, the outer edges of the latches 222 contact the faces of the grooves 212 inside the cone and engage latch contacts 224.

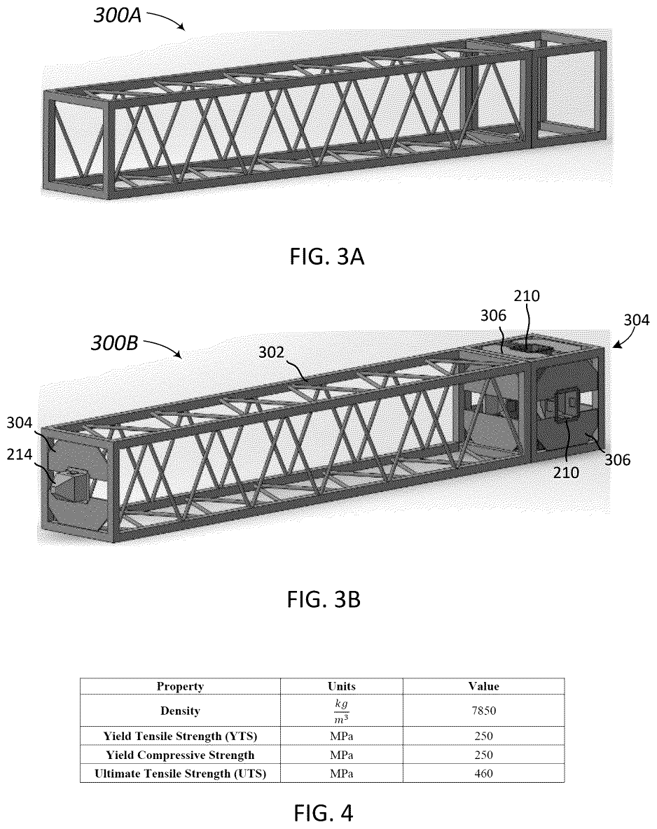

FIG. 3A is a perspective view of a unit control truss 300A. For analysis, a control group consisting of commercially available trusses is used. Commercially available truss structures for terrestrial applications are built manually using truss links bound together with connectors with fasteners (semi-permanent) or welding (permanent). For the control group, a 2 meter unit truss was used, including a 1.7×0.3×0.3 meter link and a 0.3×0.3×0.3 meter connector frame. This was modeled after an existing truss used for the construction of large structures.

FIG. 3B is a perspective view of a unit docked truss 300B, consistent with the present disclosure. For the docked truss, the unit truss includes docking adapters 200 including one or more probe adapters 214 and one or more cone adapters 210. In the docked trusses, the docking adapters 200 act as the connections that bind the trusses together rather than the trusses being welded or fastened together. In the docked truss configuration, the link may include a probe adapter 214 on each end 304. The connector frame 302 may include cone adapters 210 on each face 306. This allows for the same potential for expansion as the control truss.

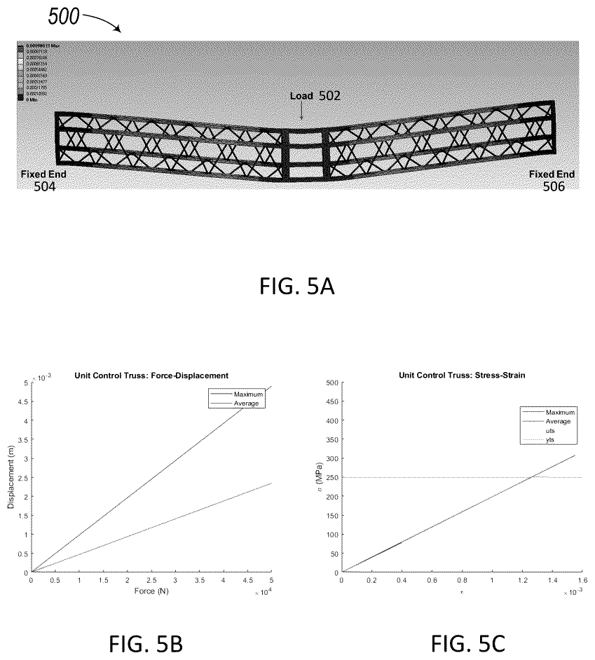

Static structural simulations were performed on the unit control truss 300A and the unit docked truss 300B. The default material, structural steel, was used for all simulations. Important material properties are shown in Table 1 (FIG. 4). For the control truss 300A, a 2 meter unit truss was used, including a 1.7×0.3×0.3 meter link and a 0.3×0.3×0.3 meter connector frame. FIG. 5A depicts the total deformation for a load of 10 N in an analysis of unit control truss 300A, while FIG. 5B is an example of a force-deformation graph for the analysis of FIG. 5A, and FIG. 5C is an example of a stress-strain graph for the analysis of FIG. 5A. Results for the unit control truss 300A show that the high-stress areas located close to the fixed ends and connector frame begin to deform plastically at higher loads. Average stress, however, is well below the Ultimate Tensile Strength (UTS) and Yield Tensile Strength (YTS).

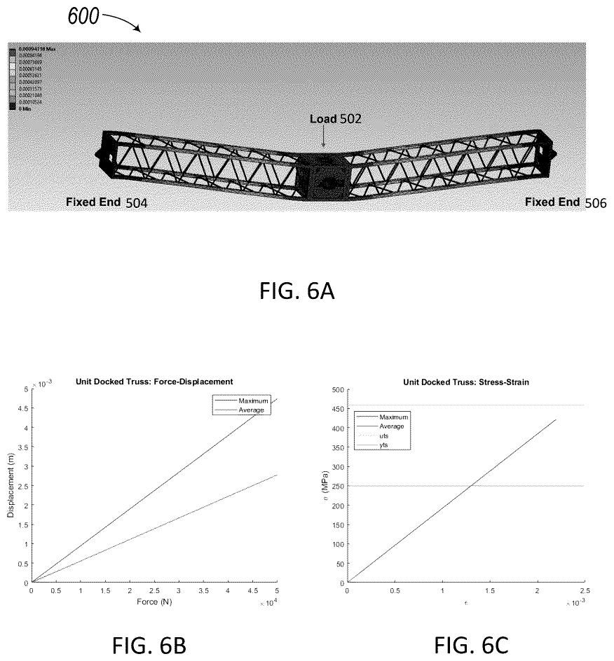

FIG. 6A depicts the total deformation for a load of 10 N in an analysis of the unit docked truss 300B, FIG. 6B is an example of a force-deformation graph for the analysis of FIG. 6A, and FIG. 6C is an example of a stress-strain graph for the analysis of FIG. 6A. Results for the unit docked truss 300B show the docked truss experiencing more displacement on average and higher maximum and average stress compared to the unit control truss 300A. This is because the control truss 300A is assumed to be welded at the interfaces, while the docked truss 300B is connected at the docking adapter latches.

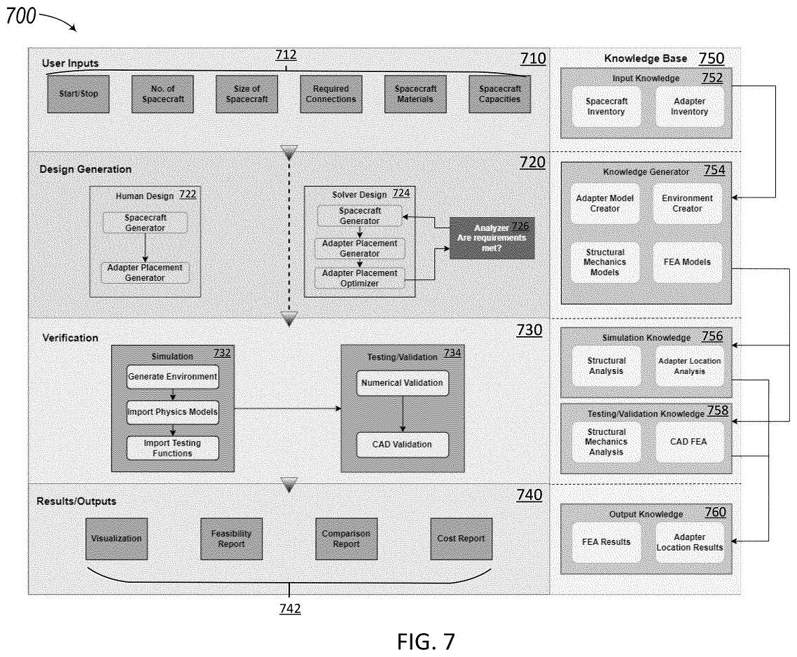

Also disclosed herein is a docking designer system 700 for small spacecraft that can be generalized for other small or large spacecraft. FIG. 7 is an illustrative block diagram of one possible architecture for system 700 for design and positioning for small spacecraft. The software tool is used to design and optimize the locations of docking adapters, for example, docking adapters 200 from FIG. 2A, on spacecraft. Factors used for analysis include required docking connections with other spacecraft, structural integrity, and properties of the spacecraft, such as size and mass/volume/power capacities. Given the rising popularity and opportunity afforded by small spacecraft, the ability for small spacecraft to dock with each other and larger spacecraft has become essential. Docking facilitates several servicing-related applications, including payload replacement, enhanced mission flexibility, space debris removal, and spacecraft subsystem maintenance. The development of small spacecraft servicing capabilities will be an integral part of the future role of small spacecraft in the burgeoning space industry.

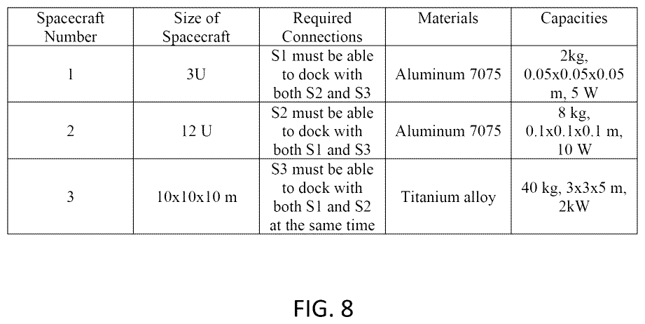

The system is composed of four main sections: user inputs circuitry 710, design generation circuitry 720, verification circuitry 730, and results/outputs circuitry 740. Starting with inputs circuitry 710, the user must specify various input parameters 712 of the spacecraft(s) they wish to equip with docking adapters. The input parameters 712 may include, but are not limited to, the number of spacecraft, size of the spacecraft (1U, 2U, 3U, 6U, 12U, etc.), required connections between spacecraft (i.e., spacecraft 1 must dock with spacecraft 2), materials the spacecraft is made of, and several capacities of the spacecraft (mass, volume, power, etc.). These input parameters 712 are used to set the parameters of the structural and computer-aided design (CAD) analysis. An example series of inputs can be seen in Table 2 (FIG. 8).

Next, a design using the specified input parameters 712 is generated by the design generation circuitry 720. Both a user 722 and a solver 724 can generate designs. In this section, the user 722 can choose where to place the necessary docking adapters to achieve the desired connections. The solver 724 will iterate through designs using an analyzer 726 that checks if the input requirements are satisfied until a sufficient design is created. Both the final user 722 and solver 724 designs will move forward into the verification circuitry 730.

After the user 722 and solver 724 designs have been generated, they are verified through simulations and testing/validation in verification circuitry 730. First, simulations 732 are run in a deep space environment with chosen testing functions. Required connections and configurations that are not possible with the generated designs are recognized here. Potential simulations 732 include dynamic and vibrational simulations that characterize the docking process, as well as power simulations that use knowledge of the spacecraft's capacities. Both numerical and CAD validation 734 are done after the simulations. This is where the structural mechanics and integrity are analyzed using Finite Element Analysis (FEA). Knowledge of the spacecraft, including materials and capacities, is used in the validation.

Using the results of the final designs and verification circuitry 730, the results 742 are generated by results/outputs circuitry 740. The results 742 may include, but are not limited to, a visualization of all spacecraft with adapter locations, a feasibility report based on the verification, a comparison report on the user and solver designs, and a cost report. With the results 742, the user can choose to end the session or go back to either the input or design generation section if the results are not satisfactory.

The system 700 uses a knowledge base 750 for design and simulation to incorporate lighting onto one or more spacecraft. Knowledge base 750 includes input knowledge 752, which may include, for example, an inventory of spacecraft and an inventory of adapters. Knowledge base 750 also includes a knowledge generator 754, which may include, for example, an adapter model creator, an environment creator, structural mechanics models, and FEA models. Knowledge base 750 may also include simulation knowledge 756, which may include, for example, structural analysis and adapter location knowledge, and testing/validation knowledge 758, which may include, for example, structural mechanics analysis and CAD FEA. Output knowledge 760 may include, for example, FEA results and adapter location results.

This system 700 is an essential tool when designing any spacecraft utilizing the docking adapters disclosed herein. The system 700 offers a comprehensive analysis of the docking adapters and their placements on small and large spacecraft alike. Using CAD and simulation design features, as well as FEA for structural and numerical analysis, the system 700 provides an interface to customize and create tailored specific spacecraft capable of docking. Furthermore, performance metrics, including cost, feasibility, and comparison reports, are generated for each design iteration to enable the user to determine each iteration's quality. The system 700 equips spacecraft designers with the necessary tools for a successful implementation of the docking adapters for any spacecraft, mission, and space environment.

In an embodiment, the utility of the truss structure is extended by utilizing its internal volume for the safe storage of resources such as battery packs, fuel, computing units, and data storage units. Further, the units can be moved inside the truss structure using a rail system. For the rail system to extend beyond the length of the truss, the docking adapter, once mated, needs to be coupled and folded to a side.

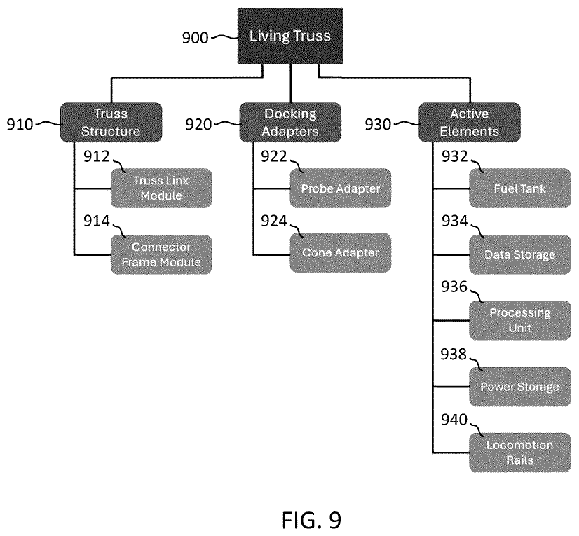

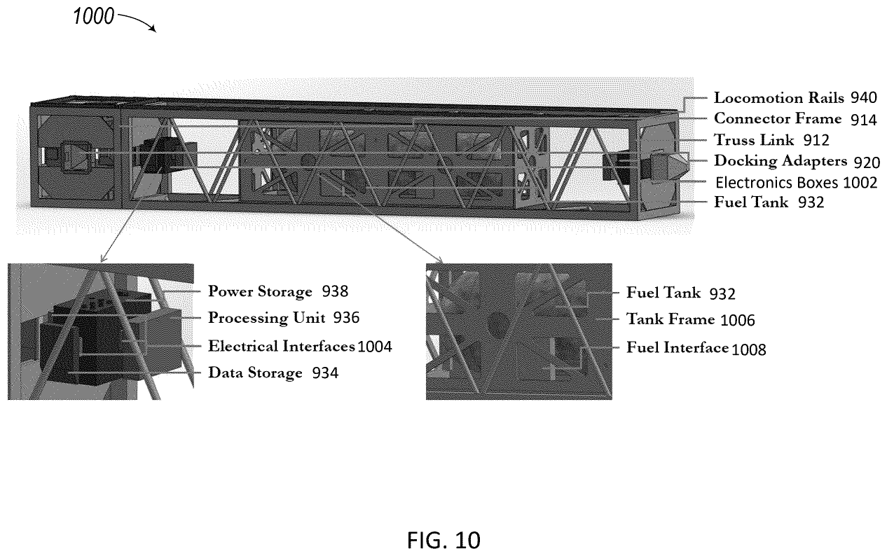

This leads to the disclosed solution, i.e., the “living” truss. The truss structure module includes a fuel tank for propellant storage, locomotion rails for transport, power storage boxes, data storage boxes, and processing units. The fuel tank is a standard thin-walled cylindrical pressure vessel with hemispherical end caps. It is located near the center of the truss structure. Power and data storage boxes and processing units are located near each docking adapter in the truss link. The locomotion rails are located on the external surface of the module. FIG. 9 is a functional block diagram and FIG. 10 is a perspective view and two detail views of a living truss, consistent with the present disclosure.

In the functional block diagram of FIG. 9, living truss 900 includes truss structure 910, docking adapters 920, and active elements 930. The truss structure 910 further includes a truss link module 912 and a connector frame module 914. The docking adapters 920 further include a probe adapter 922 and a cone adapter 924, as discussed above. The active elements 930 include a fuel tank 932, a data storage 934, a processing unit 936, a power storage 938, and a locomotion rails 940.

The addition of the fuel tank 932 and electronics boxes 1002 allows for the storage of resources such as propellant, power, and data. The transfer of these resources is done through the docking adapters 920. Compared to traditional reversible bolts and joints, the docking adapters 920 can maintain not just a structural connection but also power, data, and fuel connections. The transfer of these resources through the docking adapters 920 facilitates their transfer throughout the entire truss structure and any connected external payloads. This significantly expands the applications of these truss modules. For example, a structure consisting of truss modules may include a group of solar panels on one end of the structure. Power may need to be transferred from one end of the structure to the other. This has been done with the Integrated Truss Structure (ITS) on the ISS, which accommodates electrical and cooling utility lines.

The truss structures both house and protect the active elements inside. The tanks and electronics boxes 1002 are shielded from micro meteors and radiation inside the truss. Only fuel tank 932 and electronics boxes 1002 are detailed here, but the possibility extends to other resources such as oxidizer tanks, tools, robotics, payloads, and other general parts and equipment. The docking adapter 920 interfaces will open and move when necessary to allow for the loading and transporting resources inside the truss. The locomotion rails 940 facilitate the movement of a robotic manipulator on the external surface of the truss. The manipulator can move resources or other truss modules to construct larger truss structures.

In another aspect of the present disclosure, a system is disclosed directed to space and earth observations with telescopes placed in orbit. Disclosed herein is a reconfigurable, building-block space telescope architecture especially developed for observing fast moving targets. The key innovation is that the telescope is reconfigurable and further the telescope can pan through a zone tacking a celestial target using rotating observing systems. Further, the telescopes are stored in compact format during launch and deployed using a pop-up structure.

The disclosed space optical system with a deployable Schmidt Cassegrain-type telescope design is capable of switching the focal length of its primary optics. Previous space missions have successfully demonstrated the benefits and performance of 150 mm aperture telescopes with a focal ratio of f/10, observing near-earth asteroids and other spacecraft from a low Earth Orbit (LEO). However, the previous designs were mission specific, very expensive to produce and launch, and relied on non-standardized space bus designs.

Disclosed herein is a novel telescope design that answers these challenges with deployable structures and mechanisms for optical reconfiguration. By enabling packaging of the telescope within eight small satellites, such as standard CubeSat units, allows for significant reduction in cost and complexity. This telescope size class has never been flown on small satellite platforms, such as CubeSat and, therefore, the disclosed system represents a breakthrough in the capabilities and significant step towards more and lower cost space observatories. The dual focal system represents an enhancement of current capabilities by enabling the disclosed telescope to complete both wide field surveying and distinct targeting missions, with sensitivities capable of detecting most large asteroids and spacecrafts currently in orbit.

In the disclosed design, deployable elements include the main optical tube, internal baffles, and external baffles for stray light mitigation. After deployment, the classical Schmidt-Cassegrain Telescope (SCT) design is used at a focal ratio of f/10 with an image sensor located behind the primary mirror. By means of robotics and carefully designed adapters, the secondary mirror of the SCT can be moved away from the main optical path, modifying the SCT to a focal ratio of f/2. Corrective lens and a secondary camera are attached to the front facing corrective plate. These are masked when the secondary mirror is in place. The secondary camera can be of the Time Delay Integration type to satisfy the surveying type missions.

This technology helps bring more aperture and modularity to the CubeSat class, enabling cheaper space telescopes, diversifying observations, and opening access to space telescopes to a broader scientific community.

One key to the disclosed concept is the in-space assembly and reconfiguration of telescope units. Such modularity allows for multimission applications without the need for multiple, independent, and costly spacecraft. For example, some number of telescopes can be surveying for near earth asteroids while others observe earth, and yet others look at specific spectrum bands for events such as supernovas. The search for supernovas is currently a significant gap in surveying capabilities; the current state of the art depends primarily on amateurs and citizen science. The disclosed system is an all-in-one space station instead of multiple spacecraft, which are significantly more expensive in terms of launch cost and operations cost. The lower cost also opens the door to more users, e.g., a telescope could even be dedicated to student use.

Past disclosures have presented a stationary station concept, while the current disclosure expands this concept with a rotating space station geared towards missions which may include, but are not limited to, surveying and follow-up observations. The main motivation of these missions are full sky observations of near-earth objects, which may include asteroids for planetary defense, research, and other spacecraft.

Both previous and current platforms demonstrated the advantages of a constantly rotating spacecraft for full sky surveys. With telescopes constantly panning through the sky, both high coverage and rapid revisit have been shown. Dedicated spacecraft have been used to complete surveys of stars in our galaxy, find significant number of near-earth asteroids, and monitor Earth satellites. Yet these systems are all dedicated spacecraft with high cost and non-standard construction, presenting a high barrier to the necessary increase in spacecraft fleets and capabilities. It also limits access to underrepresented fields and narrows scientific community access to such equipment.

The disclosed design presents a solution to the cost and complexity while introducing additional capabilities. Small satellite telescope units can operate independently or as part of a multi-agent system. Each unit may include both a 150 mm aperture telescope payload and one or more universal docking adapters as key components. Units are assemble in space such that each telescope points in a different direction with the main rotation axis normal to all optical axes. A slower precession of the rotation axis is either induced, or caused by the orbit of the space station. The disclosed system builds on the existing idea of rotating spacecraft by going beyond one or two optical axes. As an unrestricted number of additional telescopes can be docked to the space station, it is possible to expand in both survey speed and observation type (e.g., supernova detection, near earth asteroids, space situational awareness, etc.). This is core to the multi-mission capability as a single space station can serve multiple scientific communities. As requirements change the space station can reconfigure autonomously, changing telescope tasking, or undocking a small satellite so it can temporarily focus on a specific target of interest. The data handling is baked into the robotic system such that operations are mission focused.

The major novelty is in the dual focal system. Essentially, the classical SCT design uses two mirrors that “bounce” the light back and forth, folding the light beam in half. The primary mirror sends light forward, then the secondary mirror reflects the light back such that the optical tube is short, and the cameras can be placed at the back of the telescope for f/10 operations. This also opens up space for devices such as filters and large sensors. There also exists a technology developed by Starzonia (Tucson Arizona) that replaces the secondary mirror with lenses, whereby the light only bounces once and the camera is at the front of the telescope, reducing the focal ratio to f/2. Depending on what is being observed there are advantages to both configurations. The disclosed system allows for switching between the two focal ratios, f/2, and f/10, robotically instead of requiring mechanical modifications.

It should be noted that for clarity this disclosure discusses the technology in terms of a 150 mm SCT operating at focal ratios of f/10 and f/2. The disclosed technology may, however, be applied to other size and types of telescopes operating at different focal ratios, as would be known to one skilled in the art.

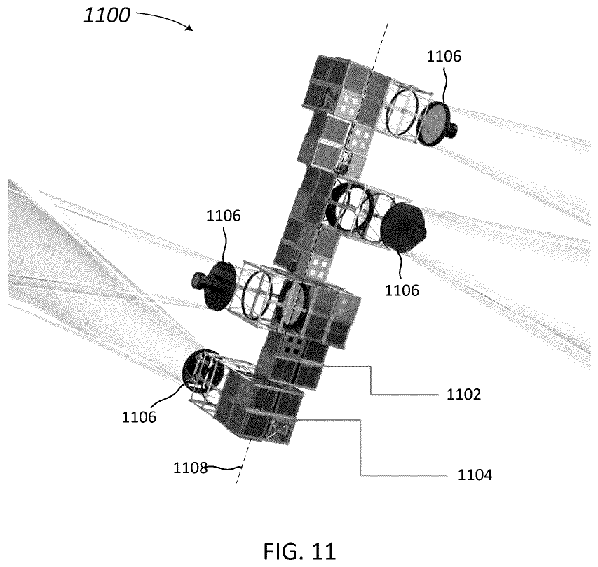

FIG. 11 is a perspective view of an illustrative example of a reconfigurable space telescope system 1100 for small satellite platforms. The reconfigurable space telescope system 1100 may use a truss structure as a platform for the survey and study of Near-Earth Objects (NEO). The multi-agent system may be constructed with standardized small satellites 1104, e.g., CubeSat spacecraft, each of which may include a 150 mm aperture deployable telescope 1106. Universal docking adapters 1102 (such as shown and described above with reference to FIGS. 2A-2C) enable on-orbit assembly and reconfiguration. The base concept is formulated around points of view distributed about a central rotation axis 1108. The constant and steady rotation allows for large area coverage and short revisit times without the need for repetitive pointing and settling times. The station is a robotic system of systems with individual agents operated autonomously according to a mission plan, which can be adapted depending on observation requirements. When docked on the main station truss, the telescope payloads follow a common mission with Attitude and Orbit Control Systems (AOCS) tasked as leaders or followers. Yet each unit can function independently, as a separate spacecraft or as part of the superstructure. Any telescope payload can be tasked to specific mission objectives. Optics are standardized with off-the-shelf components assembled into a deployable structure. The use of the small satellites also follow concepts of modularity with the ability to change the FoV, imaging methods, and spectrum bands.

The reconfigurable space telescope system 1100 is designed to be a modular, autonomous, extensible, and transformative spacecraft with the ability to add, replace, or upgrade individual units. The lifetime of the station is only limited by the willingness to replace, add, and reconfigure the station to meet the requirements for changing missions and objectives.

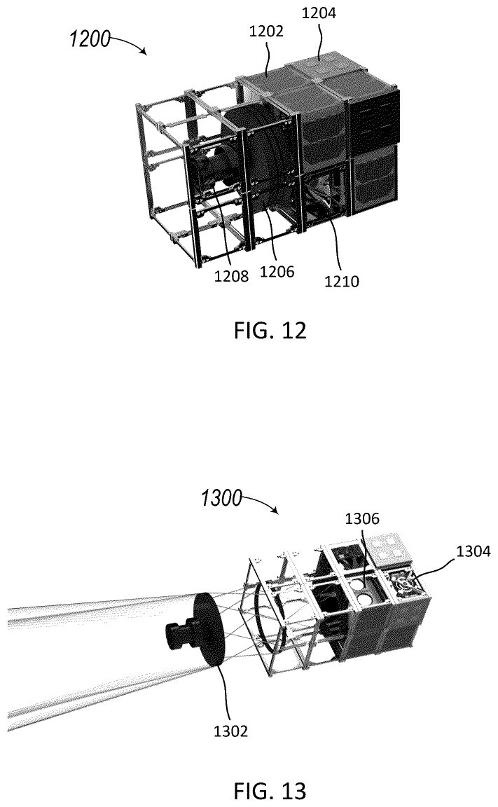

FIG. 12 is an example 16U CubeSat with a stowed 150 mm telescope. A single observing spacecraft is designed around the 16U CubeSat standard. As depicted in FIG. 12, a space of 8U is allocated to the spacecraft bus, which utilizes components of the nano spacecraft bus for orbit and attitude determination and control. The remaining volume is occupied by the folded optical train. The example of FIG. 12 includes solar panel 1202, antenna 1204, the stowed telescope 1206, the corrective lens 1208, and a female docking adapter 1210 (such as shown and described above with reference to FIGS. 2A-2C).

FIG. 13 is an example of the 16U CubeSat 300 with a telescope 1302 in the deployed configuration. The example of FIG. 13 includes thrusters 1304 and an Attitude Determination And Control System (ADCS) 1306.

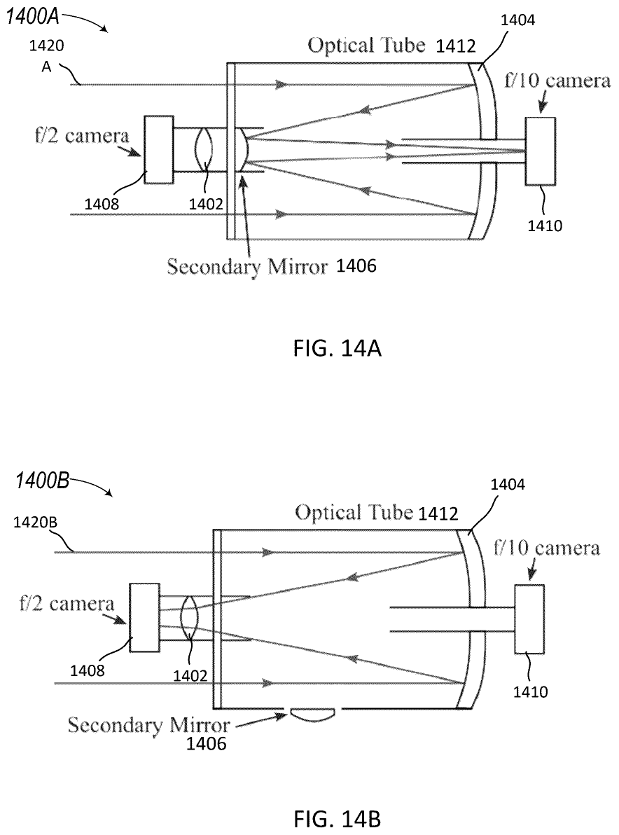

FIG. 14A depicts an optical path 1420A for the telescope 1200 of FIG. 12 at f/10, and FIG. 14B depicts an optical path 1420B for the telescope 1200 of FIG. 12 at f/2. The telescope utilizes the conventional SCT design, that may have an aperture, for example, of 150 mm. The optics include a corrector plate lens 1402, a primary mirror 1404, a secondary mirror 1408, optical tube 1412, and the two cameras, f/2 camera 1408 and f/10 camera 1410. Folding the optical path 1420A in half (FIG. 14A) allows for a long focal length of 1.5 m with a significantly shorter optical tube 1404. The secondary mirror 1408 is placed on a motorized arm (not shown) such that it can be moved out of the primary optical path 1420A. Without it the captured light in optical path 1420B goes through a set of lenses attached to the center of the corrector plate (FIG. 14B), reducing the focal length to 0.3 m. This duality in optical paths 1420A and 1420B enables a highly modular and multi-mission optical design in a single package. In an embodiment, the two operational modes may include, but are not limited to, f/10 mode and f/2 mode. In the f/10 mode (FIG. 14A), with the secondary mirror 1406 the native focal ratio is f/10 and optimized for capturing detailed images of a specific target with the spacecraft de-rotated. The imaging sensor, e.g., f/10 camera 1410, is located behind the primary mirror 1404 in conjunction with a filter wheel for comprehensive studies of targets, thereby satisfying follow-up type objectives with the spacecraft operating independently. In the f/2 mode (FIG. 14B), the secondary mirror 1406 is rotated away from the optical path 1420B and the standard SCT design is modified to a focal ratio of f/2, allowing a larger field of view optimized for full sky surveys. A dedicated Time Delay Integration (TDI) sensor (not shown) may be utilized to increase sensitivity while leveraging the advantages of the constant speed rotation of the station. Fixed filtering is possible during assembly to dedicate a unit spacecraft to surveying specific parts of the electromagnetic spectrum.

The disclosed design packages this highly modular optical design into the CubeSat standard by means of deployable structures. The corrector plate, its associated optics, and the secondary mirror actuators are attached to an extension mechanism enabling deployment and in-orbit optics alignment. Internal and external light baffles may be included and utilize meta-materials for deployment. Limited motion of the primary mirror is used for in orbit re-focusing. Overall, the use of widely available SCT optics and novel mechanisms and methods enables packaging of a 150 mm aperture within a standardized small spacecraft. This is key to enabling the disclosed modular station with standardized spacecraft units.

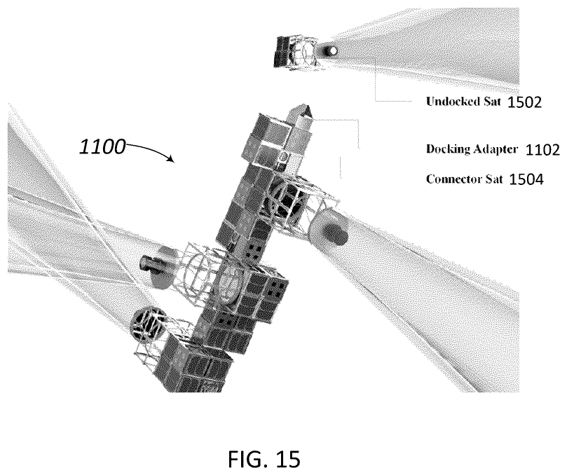

FIG. 15 is an example of station reconfiguration to task a subset of telescopes to a specific target, consistent with the present disclosure. The example of FIG. 15 includes the reconfigurable space telescope system 1100 and an undocked satellite 1502. The reconfigurable space telescope system 1100 includes the docking adapter 1102 and a connector satellite 1504.

The primary objective of the disclosed reconfigurable space telescope system 1100 is to utilize its inherent modularity to serve all aspects of a surveying mission, addressing both the needs of repeated full sky observations and detailed follow-up tasks, while assuring growth and persistent operations. The key technologies behind this capability may include the dual focal length telescope which enables packaging of two cameras and field of views within a single optical system; and the robotic operations of a multi-agent station. Such a system of systems can undertake a surveying mission with one set of telescopes operating a f/2 with broad spectrum sensors while a second set has distributed narrow band filters for follow-up observations as the station rotates. The agents are then allowed to task each other with follow-up objectives depending on the mission plan. Therefore, the disclosed single station can simultaneously fulfill missions including, but not limited to, cataloging near earth asteroids, monitoring spacecrafts in the Earth-Moon system, searching for supernovas, and much more. These missions are limited only by the number of spacecrafts in the structure. As units reach the end of life they can be separated from the station and decommissioned without ending the mission.

The standardization of units and components allows for rapid changes to the system. For example, if a task requires a specific sensor or optical filter it can be attached to the telescope in pre-assigned slots, sent to the space station at low cost, and seamlessly assimilated into its operations. From the perspective of an end user the upgrade would not be dissimilar to a software upgrade that brings new features. With capabilities distributed among multiple agents there is built in robustness of the system when faced with both failures and changing mission requirements. Notably, the agents can be undocked and parts of the station, or the entire structure can be reconfigured. For example, the system can point one or multiple telescopes at a given target and utilizing the F/10 capability of the disclosed optical system, detailed and extensive measurements of a single target are then possible, varying the sensors across spacecraft units and filters within each unit.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The present disclosure may be a system, a method, and/or a computer program product. The system or computer program product may include one or more non-transitory computer readable storage media having computer readable program instructions thereon for causing a processor to carry out aspects of the present disclosure.

The one or more non-transitory computer readable storage media can be any tangible device that can retain and store instructions for use by an instruction execution device. The one or more non-transitory computer readable storage media may be, for example, but is not limited to, an electronic storage device, a magnetic storage device, an optical storage device, an electromagnetic storage device, a semiconductor storage device, or any suitable combination of the foregoing. A non-transitory computer readable storage media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A small satellite docking adapter, the small satellite docking adapter comprising:
a probe adapter, the probe adapter including:
one or more latches;
one or more springs; and
a cone adapter, the cone adapter including:
one or more grooves, wherein:
the one or more latches are configured to couple to the one or more grooves; and
the one or more springs are configured to cause the one or more latches to engage with the one or more grooves to lock the probe adapter to the cone adapter, and to disengage with the one or more grooves to unlock the probe adapter and the cone adapter.

2. The small satellite docking adapter of claim 1, wherein the one or more springs are comprised of a Shape Memory Alloy (SMA) material.

3. The small satellite docking adapter of claim 2, wherein the one or more springs are compressed by heating the SMA material.

4. The small satellite docking adapter of claim 1, wherein allows the adapters to mate despite any x-y translational or z rotational misalignment.

5. A spacecraft, the spacecraft comprising:
one or more truss structures; and
one or more docking adapters, the one or more docking adapters configured to allow robotic assembly of the spacecraft.

6. The spacecraft of claim 5, wherein the one or more docking adapters include a probe adapter and a cone adapter.

7. The spacecraft of claim 6, wherein the probe adapter further comprises:
one or more latches; and
one or more springs, the one or more springs configured to cause the one or more latches to engage with one or more grooves in the cone adapter to lock the probe adapter to the cone adapter, and to disengage with the one or more grooves to unlock the probe adapter and the cone adapter.

8. The spacecraft of claim 6, wherein the cone adapter further comprises:
one or more grooves, the one or more grooves are configured to couple to the one or more latches.

9. A modular truss, the modular truss comprising:
a truss structure;
one or more docking adapters; and
one or more active elements.

10. The modular truss of claim 9, wherein the truss structure further comprises:
one or more truss link modules; and
one or more connector frame modules.

11. The modular truss of claim 9, wherein the one or more docking adapters further comprise:
one or more probe adapters; and
one or more cone adapters.

12. The modular truss of claim 9, wherein the active elements include at least one of one or more fuel tanks, a data storage, a processing unit, a power storage, and locomotion rails.
